(19) United States
(12) Patent Application Publication
(10) Pub. No.: US 2025/0173065 A1
(43) Pub. Date: May 29, 2025

(54) INTELLIGENT THROUGHPUT ROUTER

(71) Applicant: Micron Technology, Inc., Boise, ID (US)

(72) Inventors: Luca Porzio, Casalnuovo (NA) (IT); Rakeshkumar Dayabhai Vaghasiya, Hyderabad (IN); Roberto Izzi, Caserta (IT)

(21) Appl. No.: 18/955,713

(22) Filed: Nov. 21, 2024

Related U.S. Application Data
(60) Provisional application No. 63/603,551, filed on Nov. 28, 2023.

(51) Int. Cl. G06F 3/06

(52) U.S. Cl. CPC G06F 3/0616; G06F 3/0659; G06F 3/0679

(57) ABSTRACT

Methods, systems, and devices for an intelligent throughput router are described. A memory system may monitor parameters associated with write commands being received. The memory system may select whether to write data to a first block type (e.g., a high density cell block) or a second block type (e.g., a single-level cell block) of a non-volatile memory device based on the parameters. The memory system may store data associated with write commands in a volatile storage area such as a write buffer, and monitor the size of the write buffer. The memory system may select the first block type or the second block type based on thresholds associated with usage of the write buffer. The memory system may estimate a throughput of data associated with the write commands, and select the first block type or the second block type based on thresholds associated with the throughput of data.

### CROSS REFERENCE

The present Application for Patent claims priority to U.S. Patent Application No. 63/603,551 by Porzio et al., entitled “INTELLIGENT THROUGHPUT ROUTER,” filed Nov. 28, 2023, which is assigned to the assignee hereof, and which is expressly incorporated by reference herein.

### TECHNICAL FIELD

The following relates to one or more systems for memory, including intelligent throughput router.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports an intelligent throughput router in accordance with examples as disclosed herein.

FIG. 2 shows an example of a system that supports an intelligent throughput router in accordance with examples as disclosed herein.

FIG. 3 shows an example of a system that supports an intelligent throughput router in accordance with examples as disclosed herein.

FIG. 4 shows a block diagram of a memory system that supports an intelligent throughput router in accordance with examples as disclosed herein.

FIG. 5 shows a flowchart illustrating a method or methods that support an intelligent throughput router in accordance with examples as disclosed herein.

### DETAILED DESCRIPTION

Some memory systems may include a write booster mode. The write booster mode may allow the memory system to write information faster than a normal mode (e.g., a non-write booster mode). During the write booster mode, the memory system may write data to the single-level cell (SLC) blocks of a memory device and then move the data to higher density blocks such as multi-level cell (MLC), triple-level cell (TLC), or quad-level cell (QLC) at a later time (e.g., as part of a background or management operation). During a normal mode, the memory system may write information to a higher density cell block (e.g., MLC, TLC, QLC), which may take more time than writing information to an SLC block. In some cases, the memory device may transfer data from SLC blocks to higher density blocks in response to the memory system entering an idle or hibernation mode. While the write booster mode may temporarily improve the speed of write operations, its use may also decrease the lifetime of a memory system due at least in part to increased write amplification. Some memory systems may utilize the write booster mode by default, even while operating in low or idle modes. Such a condition can further reduce the lifetime of the memory system.

Techniques are described for improving usage of the write booster mode and SLC blocks in memory systems. In some cases, in response to the write booster mode being active, a memory system may monitor parameters associated with write commands being received by the memory system. The memory system may select whether to write data to a first block type (e.g., a high density cell block) or a second block type (e.g., a single-level cell block) of a non-volatile memory device based on the parameters being monitored. In some cases, the memory system may perform this monitoring and selecting even if the memory system is not in a write booster mode. In such cases, the memory system may dynamically select to write to SLC blocks to improve write speeds based on the monitored parameters. Some examples of the parameters being monitored may include the memory system storing data associated with write commands in a volatile storage area such as a write buffer, and monitoring the size of the write buffer being used. The memory system may select to use the first block type or the second block type based on thresholds associated with usage of the write buffer being satisfied. Some examples of the parameters being monitored may include, the memory system estimating a throughput of data based on monitoring parameters associated with the write commands such as a transfer size (i.e., data size). The memory system may select to use the first block type or the second block type based on satisfying thresholds associated with the throughput of data. By utilizing SLC blocks to store data based on satisfying various thresholds, write amplification may be reduced and the lifetime of the memory system may be increased.

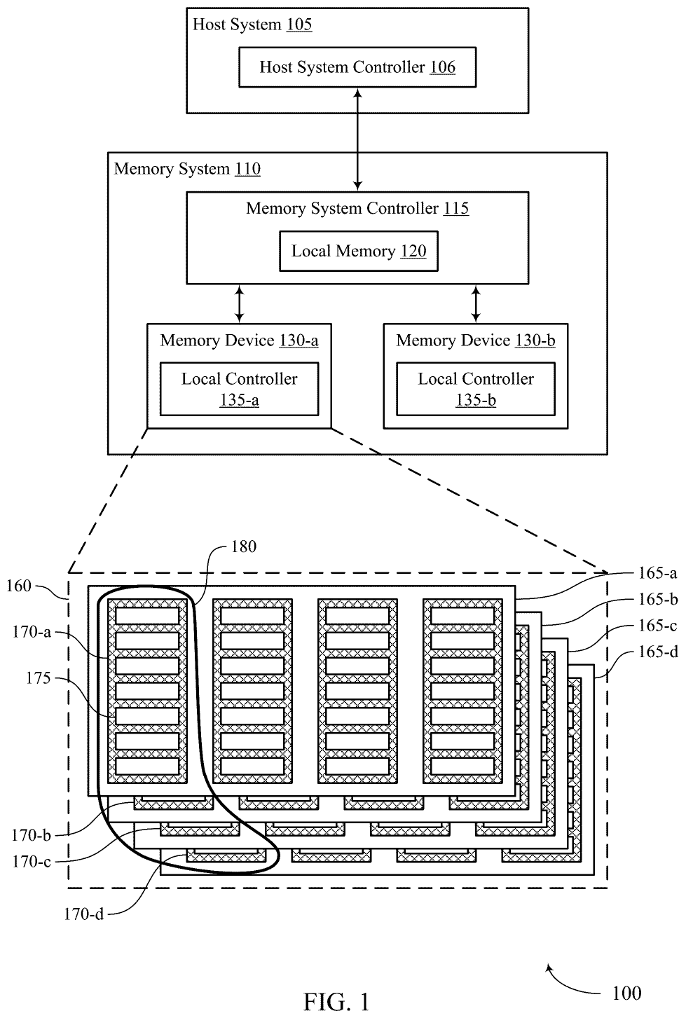

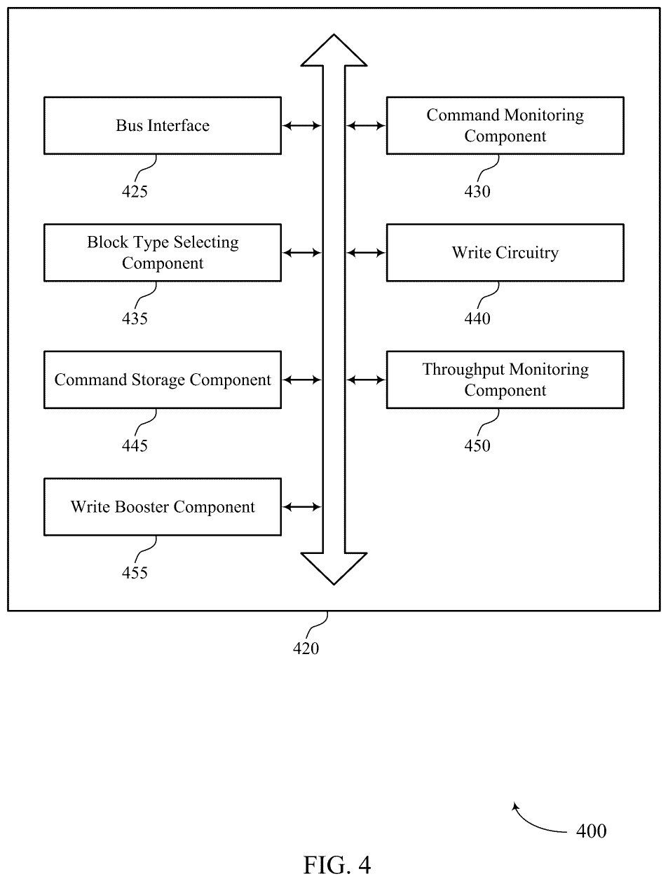

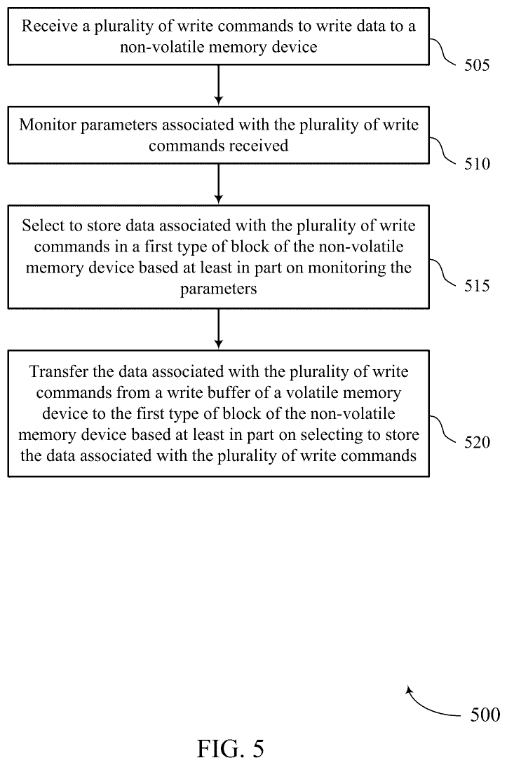

Features of the disclosure are initially described in the context of systems, devices, and circuits with reference to FIGS. 1, 2, and 3. These and other features of the disclosure are further illustrated by and described in the context of an apparatus diagram and flowchart that relate to an intelligent throughput router with reference to FIGS. 4 and 5.

FIG. 1 shows an example of a system 100 that supports intelligent throughput router in accordance with examples as disclosed herein. The system 100 includes a host system 105 coupled with a memory system 110. The system 100 may be included in a computing device such as a desktop computer, a laptop computer, a network server, a mobile device, a vehicle (e.g., train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as MLCs if configured to each store two bits of information, as TLCs if configured to each store three bits of information, as QLCs if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support intelligent throughput router. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

According to the disclosed examples, usage of the write booster mode and SLC blocks may be improved in the memory system 110. In response to the write booster mode being active, the memory system 110 may monitor parameters associated with write commands being received from the host system 105. The memory system 110 may select whether to write data to a first block type (e.g., a high density cell block) or a second block type (e.g., a single-level cell block) of the non-volatile memory cells included in the memory device 130 based on the parameters being monitored. As previously discussed, the memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

In some examples, the memory system 110 may select to write data to the first block type in response to the second block type being in use. In some cases, these selections may be made while operating in a write booster mode. In some cases these selection may be made while operating in a normal mode. In some examples, the memory system 110 may store data associated with write commands in a volatile memory device (e.g., SRAM) that includes portion allocated as a write buffer, and monitor the size of the write buffer used for storing data. The memory system 110 may select to use the first block type or the second block type based on thresholds associated with usage of the write buffer being satisfied. In some examples, the memory system 110 may estimate a throughput of data based on monitoring parameters associated with the write commands such as a transfer size (i.e., data size). The memory system 110 may select to use the first block type or the second block type based on satisfying thresholds associated with the throughput of data.

In addition to applicability in memory systems as described herein, techniques for an intelligent throughput router may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by utilizing SLC blocks to store data in response to conditions being satisfied, thereby improving memory access speeds, which may decrease latency times, improve response times, or otherwise improve user experience, among other benefits.

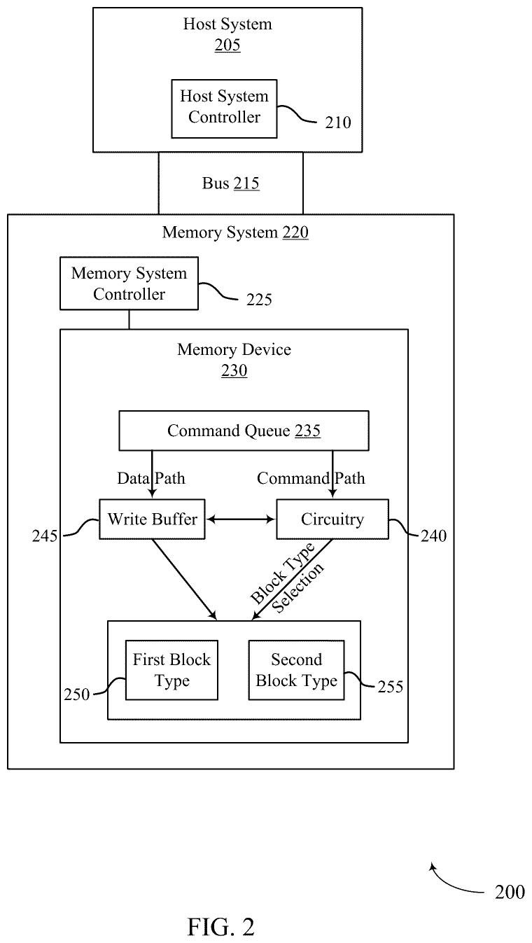

FIG. 2 shows an example of a system 200 that supports intelligent throughput routing in accordance with examples as disclosed herein. In some examples, the system 200 may implement aspects of the system 100 illustrated in FIG. 1. For example, the system 200 may include a host system 205 and a memory system 220, which may be examples of or include aspects of a host system 105 or a memory system 110 as described with reference to FIG. 1. The host system 205 may also include a host system controller 210, which may be an example of host system controller 106, described with reference to FIG. 1. The system 200 may further include a bus 215 for enabling communication between the host system 205 and the memory system 220.

The memory system 220 may include a memory system controller 225 for controlling various operations such as execution of commands received from the host system 205, controlling the data path components in moving data, etc. The memory system controller 225 may be an example of the memory system controller 115 as described with reference to FIG. 1. As illustrated in FIG. 2, the memory system 220 may include one or more memory devices 230 (only one shown) for storing data transferred between the memory system 220 and the host system 205. The memory devices 230 may include one or more volatile and/or non-volatile memory devices as described with reference to FIG. 1. For example, the memory devices 230 may include NAND memory, PCM, self-selecting memory, 3D cross point, other chalcogenide-based memories, FERAM, MRAM, NOR (e.g., NOR flash) memory, STT-MRAM, CBRAM, RRAM, or OxRAM. The data may be communicated to the one or more memory devices 230, for example, in response to receiving access commands from the host system 205. In some examples, the memory system controller 225 may control operations including, but not limited to, storing data, retrieving data, determining memory locations in which to store/retrieve data, etc. In some examples, the memory system controller 225 may communicate directly with the memory devices 230. In other examples, the memory system controller 225 may communicate with memory devices 230 via a memory device interface (not shown) using a protocol specific to the type of memory device 230.

The memory system 220 may include a command queue 235 to control processing of the access commands received from the host system 205 and the data associated with such access commands. In some examples, the memory system controller 225 may process access commands communicated to the memory system 220 by host system 205. The commands may be received through the bus 215 according to a protocol (e.g., a UFS protocol or an eMMC protocol). In some cases, the memory system controller 225 may determine, for example, that an access command has been received based on the communication from the bus 215. The memory system controller 225 may add commands communicated from the host system 205 to the command queue 235. The memory system 220 may include circuitry 240 configured, in part, for processing commands communicated from the command queue 235 via a command path. In some examples, the circuitry 240 may be configured to process access commands from the command queue 235 and determine if they include an indication of a write operation. The circuitry 240 may also determine if the memory system 220 is in write booster mode. The circuitry may also determine whether to write data to SLC blocks or to higher density cell blocks.

The memory system 220 may also include a write buffer 245 configured, in part, for storing data associated with commands stored in the command queue 235. The host system 205 may communicate data along with write commands, where the data is to be stored in the memory system 220. In some examples, the write buffer 245 may be part of a local memory (e.g., local memory 120) and may be used to temporarily store data associated with commands being processed, thereby reducing latency between commands and allowing movement of arbitrary data sizes (e.g., transfer sizes) associated with the commands. The write buffer 245 may include relatively fast memory (e.g., volatile memory, such as SRAM or DRAM), hardware accelerators, or both to allow fast storage and retrieval of data. According to some examples, the write buffer 245 may be part of a larger volatile memory component. For example, the memory system 220 may include SRAM comprising at least one allocated portion configured to operate as the write buffer 245 illustrated in FIG. 2. In other examples, the memory system 220 may include a dedicated volatile memory device (e.g., local memory 120) configured as the write buffer 245. The temporary storage of data within the write buffer 245 allows execution of some access commands with low latency by temporarily storing data associated with such access commands until the data can be moved (or transferred) to the memory devices 230. For example, writing to non-volatile memory devices can take a longer amount of time, as compared to writing to SRAM or DRAM.

According to the disclosed examples, the memory system 220 may be configured to support multiple access modes for transferring data from the write buffer 245 to the memory devices 230 (e.g., non-volatile memory devices). The access modes may correspond to block types used to store the data in the memory devices 230. The memory device 230 may store data from the write buffer 245 using a first block type 250. The memory device 230 may also store data from the write buffer 245 using a second block type 255. In some examples, the first block type 250 may be examples of higher density cell blocks such as MLC blocks, TLC blocks, or QLC blocks, among other examples of blocks. For example, two bits of information may be written to a respective memory cell of the memory device 230 in response to operating in an MLC access mode, three bits of information may be written to a respective memory cell of the memory device 230 in response to operating in a TLC access mode, four bits of information may be written to a respective memory cell of the memory device 230 in response to operating in a QLC access mode. According to the disclosed examples, the term multiple-level cell may refer to block that stores two or more bits of information in a single memory cell of the memory device 230 (e.g., MLC blocks, TLC blocks, QLC blocks).

In some examples, the second block type 255 may be examples of SLC blocks. For example, one bit of information may be written to a respective memory cell of the memory device 230 in response to operating in an SLC access mode. SLC blocks may be relatively quicker to access than higher density cell blocks and the error margins on the data stored in SLC blocks may be relatively greater than higher density cell blocks. In further examples, the first block type 250 may be associated with SLC access mode, and the second block type 255 may be associated with MLC, TLC, or QLC access modes. According to various examples, the circuitry 240 may be configured to determine if data from the write buffer 245 is to be stored using the first block type 250 or the second block type 255 of the memory device 230. In some cases, the first block type 250 may be designated as a default block type for storing data from the write buffer 245. In other cases, however, the second block type 255 may be designated as the default block type for storing data from the write buffer 245.

In some examples, the system 200 may be configured with a default access mode utilizing the default block type (e.g., the first block type 250). In the default access mode, the memory system 220 may store data from the write buffer 245 to the memory device 230 using the first block type 250. The system 200 may be configured to transition from the default access mode based on a condition such as receiving a command (e.g., write booster enable), data traffic, storage demands, system performance, threshold value associated with the command queue, threshold value associated with the write buffer, etc. In response to the condition being satisfied, the system 200 may be configured to store data from the write buffer 245 to the memory device 230 using the second block type 255.

In accordance with the disclosed examples, the host system 205 may indicate an access mode to the memory system 220. For example, the host system 205 may include a write booster component. The host system 205 may initiate the write booster component by transmitting one or more commands for one or more operations to the memory system 220. Additionally, or alternatively, the host system 205 may transmit a write booster signal to the memory system 220. In some examples, the write booster signal may provide an indication as to whether the memory system 220 is to perform access operations (e.g., transferring data from the write buffer 245) using the first block type 250 or the second block type 255. As an illustrative example, if the write booster is disabled (e.g., the host device transmits a signal indicating the write booster is disabled), the memory device 230 may transfer data from the write buffer 245 using the first block type 250 (e.g., higher density cell blocks). As another example, if the write booster is enabled (e.g., the host device transmits a signal indicating the write booster is enabled), the memory device 230 may transfer data from the write buffer 245 using the second block type 255 (e.g., SLC blocks).

In some memory systems, the determination of whether to write data to the first block type 250 (e.g., higher density cell blocks) or the second block type 255 (e.g., SLC blocks) is based on whether the write booster mode is enabled or disabled. If the write booster mode is activated, data is initially written to the second block type 255 (e.g., SLC blocks). If the write booster mode is deactivated, data is initially written to the first block type 250 (e.g., higher density cell blocks). Write booster mode includes writing initially to SLC blocks to reduce the time it takes to initially write data into the memory device 230 and then folding that data into higher density cell blocks at a later time as part of a media management operation. Such procedures may increase the write amplification of the memory system 220 and may reduce the overall lifetime of the memory system 220 (as compared to writing into higher density cell blocks) because the quantity of write performed for reach host command received is higher. Some host systems may use write booster mode too much (e.g., even if there are little to no performance benefits from using the write booster mode) and thereby reducing the lifetime of the memory system 220. Other host systems may use the write booster mode too little (e.g., incurring performance delays for writing data). Techniques are described for the memory system 220 to monitor parameters associated with the memory system 220 and to dynamically select whether to write data to SLC blocks or higher density cell blocks. In some cases, such techniques may be used as part of operating a write booster mode. In some cases, such techniques may be used in response to write booster mode being deactivated.

The system 200 may identify the block type (e.g., first block type 250 or second block type 255) for use in storing data to the memory device 230 based on various conditions. In some examples, the circuitry 240 may monitor parameters associated with write commands received from the host system 205. The circuitry 240 may monitor the size of the write buffer 245 used to store the data associated with the write commands relative to the total size of the write buffer 245. In other words, the portion of the write buffer 245 currently being used to store the data. In some examples, the circuitry 240 may select the block type for storing the data based, at least in part, on determining that a threshold size of the write buffer 245 has been satisfied. Depending on the specific type of memory device 230, the threshold may be based on a percentage of the total size of the write buffer 245. The threshold may also be based on a specific quantity, e.g., 256K, 384K, 512K, etc.

In some examples, the memory system 220 may be operating in a mode in which the first block type 250 is used to store the data, and the first block type 250 is indicative of MLC, TLC, or QLC access modes. The circuitry 240 may determine that the threshold has been satisfied and communicate a signal indicative of such status. The signal may provide an indication of the block type to be used for storing subsequent data. For example, the signal may indicate that the second block type 255 is to be used to store the data. The second block type 255 may be indicative of an SLC access mode capable of providing improved performance (e.g., improved speed) for write operations. Accordingly, the memory device 230 may transition from storing data using the first block type 250 to storing data using the second block type 255.

The techniques described herein are about using utilization of the write buffer to trigger whether to write to higher density cell blocks or SLC blocks. The present invention provides a technique for determining whether the first block type 250 (e.g., higher density cell blocks) or the second block type 255 (e.g., SLC blocks) are to be used for writing data in response to the write booster mode being enabled. Such techniques involve monitoring the utilization of the write buffer 245 of the memory system 220. Upon receiving a write command, the memory system 220 may temporarily store the data in the write buffer 245. The circuitry 240 may monitor the utilization of the write buffer 245 and determine whether to use the first block type 250 (e.g., higher density cell blocks) or the second block type 255 (e.g., SLC blocks) for writing the data.

In some examples of monitoring the utilization of the write buffer 245, the memory system 220 may determine whether the write buffer 245 may be emptied before the next data packet from the host system 205 arrives. In such examples, the memory system 220 may use the first block type 250 (e.g., higher density cell blocks) to store the data in the memory device 230. Such conditions may imply that there is little to no performance benefit to writing the data initially in the second block type 255 (e.g., SLC blocks). In such cases, the memory system 220 may determine to write the data in the first block type 250 (e.g., higher density cell blocks) to reduce the write amplification. However, if the write buffer 245 cannot be emptied before the memory system 220 is to store the next data from the host system 205, then the memory system 220 may determine to store the data in the second block type 255 (e.g., SLC blocks).

Upon transitioning to using the second block type 255 (e.g., SLC blocks), the memory system 220 may use the second block type 255 until an exit condition is identified. An example of an exit condition includes the memory system 220 determining that it is operating in an idle mode (e.g., detecting that the memory system 220 is in idle time). In such cases, the memory system 220 may fall back to using the first block type 250 (e.g., higher density cell blocks) to store the data in the memory device 230 for the next write flow. Being in an idle mode may indicate that the write buffer 245 is empty or nearly empty. Another example of an exit condition may include the memory system 220 determining whether information stored in the write buffer 245 satisfies a threshold (e.g., falls below a threshold amount). In such cases, the memory system 220 may fall back to using the first block type 250 (e.g., higher density cell blocks) to store the data in the memory device 230 for the next write flow. Being in an idle mode may indicate that the command queue 235 is empty. Another example of an exit condition may include the memory system 220 determining whether the quantity of commands in the command queue 235 satisfy a threshold (e.g., falls below a threshold amount). In such cases, the memory system 220 may fall back to using the first block type 250 (e.g., higher density cell blocks) to store the data in the memory device 230 for the next write flow.

In some examples, the circuitry 240 may determine that the memory device 230 is in an idle mode. Additionally or alternatively, the circuitry 240 may further determine information regarding the size or contents of the command queue 235. For example, the circuitry may determine that the command queue 235 is empty or contains a low threshold (e.g., 5, 10, 20, etc.) of write commands. The circuitry 240 may determine that the memory device 230 is idle and/or the command queue is empty or satisfies a low threshold. Based on such determination, the circuitry 240 may provide an indication that a transition is to be made to use the first block type 250 for storing the data. Accordingly, the memory device 230 may transition from storing data using the second block type 255 to storing data using the first block type 250.

As previously discussed, the system 200 may be configured to operate in a write booster mode. The write booster mode may be initiated (e.g., enabled) by the host system 205. For example, the host system 205 may transmit one or more commands for operations requiring the write booster mode to the memory system 220 via the bus 215. Additionally, or alternatively, the host system 205 may transmit a write booster signal to the memory system 220. If the write booster mode is initiated, the circuitry 240 may provide an indication that the second block type 255 (e.g., SLC access mode) is to be used to store the data. Thus, the memory device 230 may transition from storing data using the first block type 250 to storing data using the second block type 255. In some examples, the memory device 230 may already be using the second block type 255, and thus does not require a transition.

In some examples, the circuitry 240 may also adjust the size of the write buffer 245 based on whether the data is being written to the first block type 250 or the second block type 255. If a block includes a fixed quantity of memory cells, a TLC block may be capable of storing three times as much data as an SLC block because each memory cell in the TLC block stores three bits of data instead of storing one bit of data. In such situations, the write buffer 245 may be capable of being smaller in response to writing data in SLC blocks because less buffering is used between receiving data from the host system 205 and writing the data in the memory device 230. The circuitry 240 may use a second threshold to determine whether to vary the size of the write buffer 245 in addition to determining whether to use the higher density cell blocks or the SLC blocks. For example, the circuitry 240 may determine the threshold as 384K and determine the second threshold as 448K (i.e., 384K+64K). The circuitry 240 may wait until determining that the first threshold and/or the second threshold have been satisfied before indicating that the second block type 255 is to be used to store the data. According to the examples disclosed herein, the threshold and the second threshold may be fixed or selected based on storage demands, system performance, data traffic, cyclical (e.g., time of day, hourly, daily, weekly, etc.) usage patterns, etc. In some cases, the host system 205 may select the threshold or the second threshold or both. The memory device 230 may transition from storing data using the first block type 250 to storing data using the second block type 255 in response to the circuitry 240 determining the threshold, the second threshold, or both have been satisfied.

According to the examples disclosed herein, the circuitry 240 may continue monitoring parameters associated with the write commands as well as the size of the write buffer 245. The circuitry 240 may further determine that a third threshold has been satisfied. In some examples, the third threshold may be less than the threshold. As previously discussed, writing to the second block type 255 may result in faster transfer of data from the write buffer 245 to the memory device 230 as compared with writing to the higher density cell blocks. Therefore, the size of the write buffer 245 used to store the data may be reduced while using the second block type 255. Thus, the third threshold may be indicative of a reduction in the size of the write buffer 245. The circuitry 240 may determine that the third threshold has been satisfied and provide an indication of the block type to be used for storing subsequent data. For example, the circuitry 240 may provide an indication for transitioning back to using the first block type 250 for storing the data. Accordingly, the memory device 230 may transition from storing data using the second block type 255 to storing data using the first block type 250.

Some benefits of such techniques may include improved total bytes written (TBW) for the memory system 220, improved latency quality of service (QOS) management, and reduced battery consumption. By writing more contents to the first block type 250 (e.g., higher density cell blocks) without using the second block type 255 (e.g., SLC blocks) (even in response to being in a write booster mode), the memory system 220 may reduce its use of the second block type 255 (e.g., SLC blocks), improving overall TBW stats. Additionally, as the memory system 220 may have less data to fold from the second block type 255 (e.g., SLC blocks) to the first block type 250 (e.g., higher density cell blocks), such techniques may result in fewer media management operations that may impact the performance of performing commands from the host system 205. For example, the memory system 220 may transfer data from the second block type 255 (e.g., SLC blocks) to the first block type 250 (e.g., higher density cell blocks) during times of lower utilization. However, if the host system 205 sends a plurality of commands as the memory system 220 is performing these transfers, it may increase the latency that the memory system 220 takes to perform the commands from the host system 205. Such techniques thus may have less impact on incoming write traffic and may improve latency QoS management. Additionally, reducing the quantity of write operations to the second block type 255 and associated folding activity may result in less energy consumed by the memory system 220, thereby improving battery life.

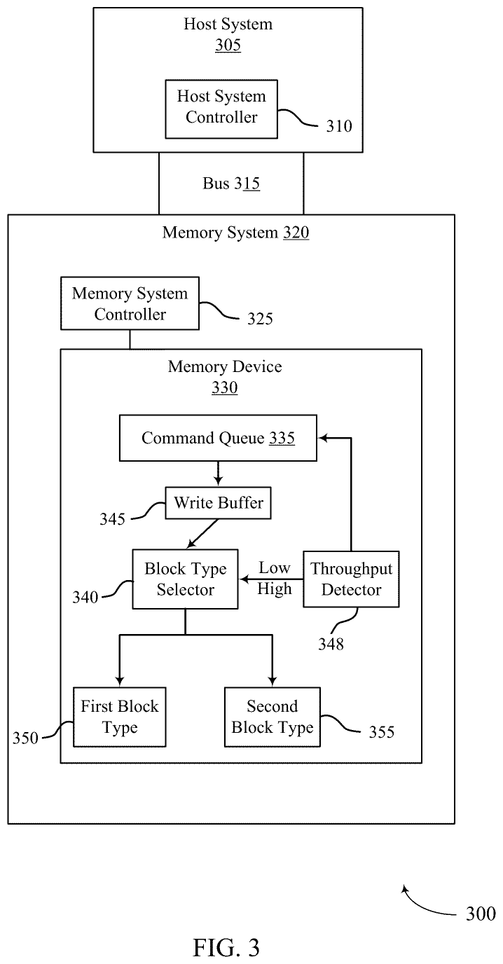

FIG. 3 shows an example of a system 300 that supports intelligent throughput routing in accordance with examples as disclosed herein. In some examples, the system 300 may implement aspects of the system 100 illustrated in FIG. 1. For example, the system 300 may include a host system 305 and a memory system 320, which may be examples of or include aspects of a host system 105 or a memory system 110 as described with reference to FIG. 1. The host system 305 may also include a host system controller 310, which may be an example of host system controller 106, described with reference to FIG. 1. The system 300 may further include a bus 315 for enabling communication between the host system 305 and the memory system 320.

The memory system 320 may include a memory system controller 325 for controlling various operations such as execution of commands received from the host system 305, controlling the data path components in moving data, etc. The memory system controller 325 may be an example of the memory system controller 115 as described with reference to FIG. 1. As illustrated in FIG. 3, the memory system 320 may include one or more memory devices 330 (only one shown) for storing data transferred between the memory system 320 and the host system 305. The memory devices 330 may include one or more volatile and/or non-volatile memory devices as described with reference to FIG. 1. For example, the memory devices 330 may include NAND memory, PCM, self-selecting memory, 3D cross point, other chalcogenide-based memories, FERAM, MRAM, NOR (e.g., NOR flash) memory, STT-MRAM, CBRAM, RRAM, or OxRAM. The data may be communicated to the one or more memory devices 330, for example, in response to receiving access commands from the host system 305. In some examples, the memory system controller 325 may control operations including, but not limited to, storing data, retrieving data, determining memory locations in which to store/retrieve data, etc. In some examples, the memory system controller 325 may communicate directly with the memory devices 330. In other examples, the memory system controller 325 may communicate with memory devices 330 via a memory device interface (not shown) using a protocol specific to the type of memory device 330.

The memory system 320 may include a command queue 335 to control processing of the access commands received from the host system 305 and the data associated with such access commands. In some examples, the memory system controller 325 may determine if an access command has been received based on the communication from the bus 315, and add the received access commands to the command queue 335. The memory system 320 may include a throughput detector 348 configured, in part, for monitoring commands in the command queue 335. The throughput detector 348 may be configured to monitor access commands from the command queue 335, determine if they include an indication of a write operation, and identify the transfer size of data associated with the write operation.

The memory system 320 may also include a write buffer 345 configured, in part, for storing data communicated from the command queue 335 via a data path. In some examples, the write buffer 345 may be used to temporarily store data as commands are being processed, thereby reducing latency between commands and allowing movement of arbitrary data sizes associated with commands. The write buffer 345 may include relatively fast memory (e.g., some types of volatile memory, such as SRAM or DRAM), hardware accelerators, or both to allow fast storage and retrieval of data. According to some examples, the write buffer 345 may be part of a larger volatile memory component. For example, the memory system 320 may include SRAM comprising at least one allocated portion configured to operate as the write buffer 345 illustrated in FIG. 3. In other examples, the memory system 320 may include a dedicated volatile memory chip configured as the write buffer 345.

The system 300 may be an example of a controller-based solution to determine whether to use the first block type 350 or the second block type 255. The system 300 may include a block type selector 340 and a throughput detector 348. In some examples, the throughput detector 348 may monitor the content of the command queue 335 in order to determine the throughput of data associated with the received write commands. For example, the throughput detector 348 may examine commands in the command queue 335 to determine if they are associated with a write access operation (e.g., write commands). The throughput detector 348 may further determine the transfer size associated with each write command. For example, the throughput detector 348 may determine that the write command is associated with a transfer block of 4K, 16K, 32K, 64K, etc. In some examples, the throughput detector 348 may determine a throughput (or amount) of data to be written over a time interval. The time interval may be selected based on various factors, including the type of memory device 330, the amount of write commands contained in the command queue 335, etc. According to at least one example, the throughput detector 348 may determine the throughput based on the Equation 1.

### Throughput Estimation

Throughput Estimation=Σᵢ₌ₜ^{t+T}WriteTransferSize(i) (1)

In Equation 1 the WriteTransferSize (i) is the size of data blocks associated with each write command, T is the selected time interval, and t is the current time.

The throughput detector 348 may determine that the amount of data associated with the write commands currently in the command queue 335 are at a high level or a low level based on the estimated throughput value. The throughput detector 348 may provide an indication of the level (e.g., high or low) to the block type selector 340. The block type selector 340 may select either the first block type 350 or the second block type 355 for storing data from the write buffer 345.

In some examples, the memory system 320 may be operating in a mode in which the first block type 350 is used to store the data from the write buffer 345. The first block type 350 may be indicative of MLC, TLC, or QLC access modes. The throughput detector 348 may determine that the throughput of data (e.g., estimated throughput) associated with write commands in the command queue 335 is at a high level. In some examples, the throughput detector 348 may determine if the throughput is at a high level or a low level based on a threshold being satisfied. The throughput detector 348 may provide an appropriate indication to the block type selector 340. The block type selector 340 may select the second block type 355 for storing the data to the memory device 330 based on indication from the throughput detector 348. In such examples, the second block type 355 may be indicative of an SLC access mode capable of providing improved performance for write operations. Thus, the memory device 330 may transition from storing data using the first block type 350 to storing data using the second block type 355.

The throughput detector 348 may continue to monitor parameters associated with the write commands in the command queue 335, such as the throughput of data. The throughput detector 348 may further determine that the throughput level no longer satisfies the threshold (e.g., the throughput level is lower than the threshold). Thus, the throughput detector 348 may determine that the throughput is at a low level, and provide an appropriate indication to the block type selector 340. The block type selector 340 may select the first block type 350 (e.g., MLC, TLC, or QLC access modes) for storing the data to the memory device 330 based on indication from the throughput detector 348. The memory device 330 may therefore transition from storing data using the second block type 355 to storing data using the first block type 350.

In some examples, the throughput detector 348 may further examine the transfer size associated with one or more write commands. If a threshold quantity of write commands contain a transfer size exceeding a set value (64K, 128K, etc.), the throughput detector 348 may provide an indication of high level throughput to the block type selector 340. In some examples, the throughput detector 348 may provide the indication of high level throughput based on both the throughput of data (e.g., estimated throughput) associated with the write commands over the interval and the transfer size associated with write commands exceeding the set value.

In some examples, throughput detector 348 may estimate the throughput capability of the memory system 320. In operation, if the estimated throughput value is within the throughput capability of the first block type 350 (e.g., higher density cell blocks), the throughput detector 348 may indicate to the block type selector 340 to use the first block type 350 (e.g., higher density cell blocks) to store write data. On the other hand, if the estimated throughput value is above the throughput capability of the first block type 350 (e.g., higher density cell blocks), the throughput detector 348 may indicate to the block type selector 340 to use the second block type 355 (e.g., SLC blocks) to store write traffic. In some cases, the throughput detector 348 may also determine whether the write booster mode is enabled or disabled. In some examples of such cases, the throughput detector 348 may be configured to make these determinations in response to the write booster mode being enabled. In some examples of such cases, the throughput detector 348 may be configured to make these determinations regardless of whether the write booster mode is enabled or disabled.

FIG. 4 shows a block diagram 400 of a memory system 420 that supports intelligent throughput router in accordance with examples as disclosed herein. The memory system 420 may be an example of aspects of a memory system as described with reference to FIGS. 1 through 3. The memory system 420, or various components thereof, may be an example of means for performing various aspects of intelligent throughput router as described herein. For example, the memory system 420 may include a bus interface 425, a command monitoring component 430, a block type selecting component 435, a write circuitry 440, a command storage component 445, a throughput monitoring component 450, a write booster component 455, or any combination thereof. Each of these components may communicate, directly or indirectly, with one another (e.g., via one or more buses).

The bus interface 425 may be configured as or otherwise support a means for receiving a plurality of write commands to write data to a non-volatile memory device. The command monitoring component 430 may be configured as or otherwise support a means for monitoring parameters associated with the plurality of write commands received. The block type selecting component 435 may be configured as or otherwise support a means for selecting to store data associated with the plurality of write commands in a first type of block of the non-volatile memory device based at least in part on monitoring the parameters. The write circuitry 440 may be configured as or otherwise support a means for transferring the data associated with the plurality of write commands from a write buffer of a volatile memory device to the first type of block of the non-volatile memory device based at least in part on selecting to store the data associated with the plurality of write commands.

In some examples, the block type selecting component 435 may be configured as or otherwise support a means for transitioning from writing the data to the first type of block to writing the data to a second type of block of the non-volatile memory device based at least in part on monitoring the parameters associated with the plurality of write commands.

In some examples, the block type selecting component 435 may be configured as or otherwise support a means for transitioning from writing the data to a second type of block to writing the data to the first type of block of the non-volatile memory device based at least in part on monitoring the parameters associated with the plurality of write commands.

In some examples, to support transferring the data associated with the plurality of write commands, the command storage component 445 may be configured as or otherwise support a means for storing the data to the write buffer of the volatile memory device.

In some examples, the first type of block of the non-volatile memory device includes a multi-level cell block, a triple-level cell block, or a quad-level cell block. In some examples, a second type of block of the non-volatile memory device includes a single-level cell block.

In some examples, the first type of block of the non-volatile memory device includes a single-level cell block. In some examples, a second type of block of the non-volatile memory device includes a multi-level cell block, a triple-level cell block, or a quad-level cell block.

In some examples, to support monitoring the parameters associated with the plurality of write commands, the throughput monitoring component 450 may be configured as or otherwise support a means for determining a throughput of the data associated with the plurality of write commands over a time interval, where selecting to store the data associated with the plurality of write commands is based at least in part on the throughput of the data associated with the plurality of write commands over the time interval satisfying a threshold.

In some examples, the throughput of the data is based at least in part on a transfer size associated with each of the plurality of write commands.

In some examples, to support selecting to store data associated with the plurality of write commands, the command monitoring component 430 may be configured as or otherwise support a means for transitioning from the first type of block to a second type of block or from the second type of block to the first type of block based at least in part on the throughput of the data associated with the plurality of write commands over the time interval satisfying a second threshold.

In some examples, to support monitoring the parameters associated with the plurality of write commands received, the command monitoring component 430 may be configured as or otherwise support a means for determining a size of the write buffer used to store the data associated with the plurality of write commands, where selecting to store the data associated with the plurality of write commands is based at least in part on the size of the write buffer used to store the data satisfying a threshold.

In some examples, the command monitoring component 430 may be configured as or otherwise support a means for selecting to store the data associated with the plurality of write commands based at least in part on the size of the write buffer used to store the data exceeding a second threshold that is greater than the threshold.

In some examples, the block type selecting component 435 may be configured as or otherwise support a means for transitioning from the first type of block to a second type of block or from the second type of block to the first type of block based at least in part on the size of the write buffer used to store the data satisfying a third threshold.

In some examples, to support monitoring the parameters associated with the plurality of write commands received, the command monitoring component 430 may be configured as or otherwise support a means for determining whether the non-volatile memory device is in an idle mode. In some examples, to support monitoring the parameters associated with the plurality of write commands received, the command monitoring component 430 may be configured as or otherwise support a means for determining whether a command queue associated with the write buffer is empty of the plurality of write commands, where selecting to store the data in the first type of block based at least in part on determining whether the non-volatile memory device is in the idle mode and determining whether the write buffer is empty.

In some examples, the command monitoring component 430 may be configured as or otherwise support a means for determining whether the command queue satisfies a threshold, where selecting to store the data in the first type of block based at least in part on determining whether the command queue satisfies the threshold.

In some examples, the block type selecting component 435 may be configured as or otherwise support a means for determining whether an amount of data in the write buffer satisfies a threshold, where selecting to store the data in the first type of block based at least in part on determining whether the amount of data in the write buffer satisfies the threshold.

In some examples, the write booster component 455 may be configured as or otherwise support a means for initiating a write booster mode of the non-volatile memory device, where monitoring the parameters is based at least in part on initiating the write booster mode.

FIG. 5 shows a flowchart illustrating a method 500 that supports intelligent throughput router in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the wireless memory system may perform aspects of the described functions using special-purpose hardware.

At 505, the method may include receiving a plurality of write commands to write data to a non-volatile memory device. The operations of 505 may be performed in accordance with examples as disclosed herein. In some examples, aspects of the operations of 505 may be performed by a bus interface 425 as described with reference to FIG. 4.

At 510, the method may include monitoring parameters associated with the plurality of write commands received. The operations of 510 may be performed in accordance with examples as disclosed herein. In some examples, aspects of the operations of 510 may be performed by a command monitoring component 430 as described with reference to FIG. 4.

At 515, the method may include selecting to store data associated with the plurality of write commands in a first type of block of the non-volatile memory device based at least in part on monitoring the parameters. The operations of 515 may be performed in accordance with examples as disclosed herein. In some examples, aspects of the operations of 515 may be performed by a block type selecting component 435 as described with reference to FIG. 4.

At 520, the method may include transferring the data associated with the plurality of write commands from a write buffer of a volatile memory device to the first type of block of the non-volatile memory device based at least in part on selecting to store the data associated with the plurality of write commands. The operations of 520 may be performed in accordance with examples as disclosed herein. In some examples, aspects of the operations of 520 may be performed by a write circuitry 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a plurality of write commands to write data to a non-volatile memory device; monitoring parameters associated with the plurality of write commands received; selecting to store data associated with the plurality of write commands in a first type of block of the non-volatile memory device based at least in part on monitoring the parameters; and transferring the data associated with the plurality of write commands from a write buffer of a volatile memory device to the first type of block of the non-volatile memory device based at least in part on selecting to store the data associated with the plurality of write commands.

Aspect 2: The method, apparatus, or non-transitory computer-readable medium of aspect 1, further including operations, features, circuitry, logic, means, or instructions, or any combination thereof for transitioning from writing the data to the first type of block to writing the data to a second type of block of the non-volatile memory device based at least in part on monitoring the parameters associated with the plurality of write commands.

Aspect 3: The method, apparatus, or non-transitory computer-readable medium of any of aspects 1 through 2, further including operations, features, circuitry, logic, means, or instructions, or any combination thereof for transitioning from writing the data to a second type of block to writing the data to the first type of block of the non-volatile memory device based at least in part on monitoring the parameters associated with the plurality of write commands.

Aspect 4: The method, apparatus, or non-transitory computer-readable medium of any of aspects 1 through 3, where transferring the data associated with the plurality of write commands further includes operations, features, circuitry, logic, means, or instructions, or any combination thereof for storing the data to the write buffer of the volatile memory device.

Aspect 5: The method, apparatus, or non-transitory computer-readable medium of any of aspects 1 through 4, where the first type of block of the non-volatile memory device includes a multi-level cell block, a triple-level cell block, or a quad-level cell block and a second type of block of the non-volatile memory device includes a single-level cell block.

Aspect 6: The method, apparatus, or non-transitory computer-readable medium of any of aspects 1 through 5, where the first type of block of the non-volatile memory device includes a single-level cell block and a second type of block of the non-volatile memory device includes a multi-level cell block, a triple-level cell block, or a quad-level cell block.

Aspect 7: The method, apparatus, or non-transitory computer-readable medium of any of aspects 1 through 6, where monitoring the parameters associated with the plurality of write commands further includes operations, features, circuitry, logic, means, or instructions, or any combination thereof for determining a throughput of the data associated with the plurality of write commands over a time interval, where selecting to store the data associated with the plurality of write commands is based at least in part on the throughput of the data associated with the plurality of write commands over the time interval satisfying a threshold.

Aspect 8: The method, apparatus, or non-transitory computer-readable medium of aspect 7, where the throughput of the data is based at least in part on a transfer size associated with each of the plurality of write commands.

Aspect 9: The method, apparatus, or non-transitory computer-readable medium of any of aspects 7 through 8, where selecting to store data associated with the plurality of write commands further includes operations, features, circuitry, logic, means, or instructions, or any combination thereof for transitioning from the first type of block to a second type of block or from the second type of block to the first type of block based at least in part on the throughput of the data associated with the plurality of write commands over the time interval satisfying a second threshold.

Aspect 10: The method, apparatus, or non-transitory computer-readable medium of any of aspects 1 through 9, where monitoring the parameters associated with the plurality of write commands received further includes operations, features, circuitry, logic, means, or instructions, or any combination thereof for determining a size of the write buffer used to store the data associated with the plurality of write commands, where selecting to store the data associated with the plurality of write commands is based at least in part on the size of the write buffer used to store the data satisfying a threshold.

Aspect 11: The method, apparatus, or non-transitory computer-readable medium of aspect 10, further including operations, features, circuitry, logic, means, or instructions, or any combination thereof for selecting to store the data associated with the plurality of write commands based at least in part on the size of the write buffer used to store the data exceeding a second threshold that is greater than the threshold.

Aspect 12: The method, apparatus, or non-transitory computer-readable medium of any of aspects 10 through 11, further including operations, features, circuitry, logic, means, or instructions, or any combination thereof for transitioning from the first type of block to a second type of block or from the second type of block to the first type of block based at least in part on the size of the write buffer used to store the data satisfying a third threshold.

Aspect 13: The method, apparatus, or non-transitory computer-readable medium of any of aspects 1 through 12, where monitoring the parameters associated with the plurality of write commands received further includes operations, features, circuitry, logic, means, or instructions, or any combination thereof for determining whether the non-volatile memory device is in an idle mode and determining whether a command queue associated with the write buffer is empty of the plurality of write commands, where selecting to store the data in the first type of block based at least in part on determining whether the non-volatile memory device is in the idle mode and determining whether the write buffer is empty.

Aspect 14: The method, apparatus, or non-transitory computer-readable medium of aspect 13, further including operations, features, circuitry, logic, means, or instructions, or any combination thereof for determining whether the command queue satisfies a threshold, where selecting to store the data in the first type of block based at least in part on determining whether the command queue satisfies the threshold.

Aspect 15: The method, apparatus, or non-transitory computer-readable medium of any of aspects 13 through 14, further including operations, features, circuitry, logic, means, or instructions, or any combination thereof for determining whether an amount of data in the write buffer satisfies a threshold, where selecting to store the data in the first type of block based at least in part on determining whether the amount of data in the write buffer satisfies the threshold.

Aspect 16: The method, apparatus, or non-transitory computer-readable medium of any of aspects 1 through 15, further including operations, features, circuitry, logic, means, or instructions, or any combination thereof for initiating a write booster mode of the non-volatile memory device, where monitoring the parameters is based at least in part on initiating the write booster mode.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a controller associated with a memory device, wherein the controller is configured to cause the apparatus to:
receive a plurality of write commands to write data to a non-volatile memory device;
monitor parameters associated with the plurality of write commands received;
select to store data associated with the plurality of write commands in a first type of block of the non-volatile memory device based at least in part on monitoring the parameters; and
transfer the data associated with the plurality of write commands from a write buffer of a volatile memory device to the first type of block of the non-volatile memory device based at least in part on selecting to store the data associated with the plurality of write commands.

2. The apparatus of claim 1, wherein the controller is further configured to cause the apparatus to:
transition from writing the data to the first type of block to writing the data to a second type of block of the non-volatile memory device based at least in part on monitoring the parameters associated with the plurality of write commands.

3. The apparatus of claim 1, wherein the controller is further configured to cause the apparatus to:
transition from writing the data to a second type of block to writing the data to the first type of block of the non-volatile memory device based at least in part on monitoring the parameters associated with the plurality of write commands.

4. The apparatus of claim 1, wherein transferring the data associated with the plurality of write commands is further configured to cause the apparatus to:
store the data to the write buffer of the volatile memory device.

5. The apparatus of claim 1, wherein:
the first type of block of the non-volatile memory device comprises a multi-level cell block, a triple-level cell block, or a quad-level cell block; and
a second type of block of the non-volatile memory device comprises a single-level cell block.

6. The apparatus of claim 1, wherein:
the first type of block of the non-volatile memory device comprises a single-level cell block; and
a second type of block of the non-volatile memory device comprises a multi-level cell block, a triple-level cell block, or a quad-level cell block.

7. The apparatus of claim 1, wherein monitoring the parameters associated with the plurality of write commands is further configured to cause the apparatus to:
determine a throughput of the data associated with the plurality of write commands over a time interval, wherein selecting to store the data associated with the plurality of write commands is based at least in part on the throughput of the data associated with the plurality of write commands over the time interval satisfying a threshold.

8. The apparatus of claim 7, wherein the throughput of the data is based at least in part on a transfer size associated with each of the plurality of write commands.

9. The apparatus of claim 7, wherein selecting to store data associated with the plurality of write commands is further configured to cause the apparatus to:
transition from the first type of block to a second type of block or from the second type of block to the first type of block based at least in part on the throughput of the data associated with the plurality of write commands over the time interval satisfying a second threshold.

10. The apparatus of claim 1, wherein monitoring the parameters associated with the plurality of write commands received is further configured to cause the apparatus to:
determine a size of the write buffer used to store the data associated with the plurality of write commands, wherein selecting to store the data associated with the plurality of write commands is based at least in part on the size of the write buffer used to store the data satisfying a threshold.

11. The apparatus of claim 10, wherein the controller is further configured to cause the apparatus to:
select to store the data associated with the plurality of write commands based at least in part on the size of the write buffer used to store the data exceeding a second threshold that is greater than the threshold.

12. The apparatus of claim 10, wherein the controller is further configured to cause the apparatus to:
transition from the first type of block to a second type of block or from the second type of block to the first type of block based at least in part on the size of the write buffer used to store the data satisfying a third threshold.

13. The apparatus of claim 1, wherein monitoring the parameters associated with the plurality of write commands received is further configured to cause the apparatus to:
determine whether the non-volatile memory device is in an idle mode; and
determine whether a command queue associated with the write buffer is empty of the plurality of write commands, wherein selecting to store the data in the first type of block based at least in part on determining whether the non-volatile memory device is in the idle mode and determining whether the write buffer is empty.

14. The apparatus of claim 13, wherein the controller is further configured to cause the apparatus to:
determine whether the command queue satisfies a threshold, wherein selecting to store the data in the first type of block based at least in part on determining whether the command queue satisfies the threshold.

15. The apparatus of claim 13, wherein the controller is further configured to cause the apparatus to:
determine whether an amount of data in the write buffer satisfies a threshold, wherein selecting to store the data in the first type of block based at least in part on determining whether the amount of data in the write buffer satisfies the threshold.

16. The apparatus of claim 1, wherein the controller is further configured to cause the apparatus to:
initiate a write booster mode of the non-volatile memory device, wherein monitoring the parameters is based at least in part on initiating the write booster mode.

17. A non-transitory computer-readable medium storing code, the code comprising instructions executable by a processor to:
receive a plurality of write commands to write data to a non-volatile memory device;
monitor parameters associated with the plurality of write commands received;
select to store data associated with the plurality of write commands in a first type of block of the non-volatile memory device based at least in part on monitoring the parameters; and
transfer the data associated with the plurality of write commands from a write buffer of a volatile memory device to the first type of block of the non-volatile memory device based at least in part on selecting to store the data associated with the plurality of write commands.

18. The non-transitory computer-readable medium of claim 17, wherein the instructions are further executable by the processor to:
transition from writing the data to the first type of block to writing the data to a second type of block of the non-volatile memory device based at least in part on monitoring the parameters associated with the plurality of write commands.

19. The non-transitory computer-readable medium of claim 17, wherein the instructions are further executable by the processor to:
transition from writing the data to a second type of block to writing the data to the first type of block of the non-volatile memory device based at least in part on monitoring the parameters associated with the plurality of write commands.

20. A method, comprising:
receiving a plurality of write commands to write data to a non-volatile memory device;
monitoring parameters associated with the plurality of write commands received;
selecting to store data associated with the plurality of write commands in a first type of block of the non-volatile memory device based at least in part on monitoring the parameters; and
transferring the data associated with the plurality of write commands from a write buffer of a volatile memory device to the first type of block of the non-volatile memory device based at least in part on selecting to store the data associated with the plurality of write commands.
